(19) United States
(12) Patent Application Publication
(10) Pub. No.: US 2015/0199339 A1
(43) Pub. Date: Jul. 16, 2015

(54) SEMANTIC REFINING OF CROSS-LINGUAL INFORMATION RETRIEVAL RESULTS

(71) Applicant: XEROX CORPORATION, Norwalk, CT (US)

(72) Inventors: Shachar MIRKIN, Meylan (FR); Nikolaos LAGOS, Grenoble (FR); loan CALAPODESCU, Grenoble (FR)

(73) Assignee: XEROX CORPORATION, Norwalk, CT (US)

(21) Appl. No.: 14/276,252

(22) Filed: May 13, 2014

Related U.S. Application Data
(60) Provisional application No. 61/927,138, filed on Jan. 14, 2014.

(51) Int. Cl. G06F 17/28; G06F 17/30

(52) U.S. Cl. CPC G06F 17/289; G06F 17/30669; G06F 17/30696; G06F 17/30011; G06F 17/30684

(57) ABSTRACT

A method for cross language information retrieval includes receiving an input query which includes at least one word in a source language and translating the input query from the source language to a target language to provide a set of translated queries. A set of documents is retrieved from a document collection based on the translated queries. The retrieved documents are translated back into the source language to generate a set of translated documents. An entailment relationship between each of the translated documents and the input query is assessed. The set of translated documents is refined, based on the assessment of the entailment relationship. A subset (or all) of the refined set of translated documents, and/or the target documents to which the translated documents in the subset correspond, is output.

This application claims the priority of U.S. Provisional Application Ser. No. 61/927,138, filed Jan. 14, 2014, entitled SEMANTIC REFINING OF CROSS-LINGUAL INFORMATION RETRIEVAL RESULTS, the disclosure of which is incorporated herein by reference in its entirety.

### BACKGROUND

Aspects of the exemplary embodiment disclosed herein relate to cross language information retrieval (CLIR) and find particular application in connection with a system and method for refining results of a CLIR system.

CLIR systems are now widely used for retrieving documents in one language based on a query input in another language. They are useful tools, particularly when the domain of interest is largely in a different language from that of an information searcher. A common way to handle this task is first to translate the input query, using a bilingual dictionary or an automatic Statistical Machine Translation (SMT) system, into the language used in the target documents. The translated query is then input to a search engine for querying a selected target language document collection.

Some SMT systems output more than one translation of a query and it has been found that using the n-best translations, i.e., those translations that were given the n highest scores by the SMT system, produces better results than using the single-best translation (see, Nikoulina, et al., “Adaptation of statistical machine translation model for cross-lingual information retrieval in a service context,” EACL '12, pp. 109-119, ACL (2012), hereinafter, “Nikoulina 2012”). Using multiple translations adds variations to the query that can also be matched in the documents. This directly leads to improvement in recall, but can also negatively impact precision.

As an example, suppose that the aim is to retrieve relevant documents in French for the English query european educational systems. One good translation of this query is les systèmes de formation européens. From an n-best list, the other translations could also be obtained, such as: (2) les systèmes d'éducation européen; (3) les systèmes éducatifs européens; and (4) les systèmes européens d'éducation. These alternatives supplement the first translated query in various ways. Translation (2), for example, adds a relevant term éducation that is likely to help retrieve more relevant documents, and therefore may positively impact the system's recall. Translations (3) and (4) can further increase recall.

One problem which arises is that SMT systems designed for general text translation tend to perform poorly when used for query translation. SMT systems are often trained on a corpus of parallel sentences (pairs of a source sentence and its translation). Such corpora are often automatically extracted from a parallel corpus of documents. The documents in the corpus are assumed to be translations of each other, at least in the source to target direction. They are often translations of texts or spoken language, and are generally coherent. The trained SMT systems thus implicitly take into account the phrase structure. However, the structure of queries can be very different from the standard phrase structure used in general text. For example, queries are often very short translation of texts or spoken language, and may not constitute coherent language phrases, as is the case when word order is not preserved or when prepositions are eliminated (e.g., “python sort list” may be used as a query to represent the information needed: “sorting lists in python”). Further, ambiguity in queries can result in incorrect translations, which can result in retrieving non-relevant documents. For instance, the query chess for beginners can be translated using the French word échecs. The word échecs is ambiguous, meaning both chess and failures. This latter translation would likely retrieve non-relevant documents and consequently would negatively impact the system's precision.

There remains a need for a system and method for cross language information retrieval that improves the retrieval of relevant target language documents while benefiting from the use of multiple query translations.

### INCORPORATION BY REFERENCE

The following references, the disclosures of which are incorporated herein by reference in its entirety, are mentioned:

U.S. application Ser. No. 13/479,648, filed May 24, 2012, entitled DOMAIN ADAPTATION FOR QUERY TRANSLATION, by Vassilina Nikoulina, et al., discloses a translation method which includes translating a query to generate a set of candidate translations. Features are extracted from each of the candidate translations, including a domain specific feature which is based on a comparison of at least one term in the candidate translation with words in a domain-specific corpus of documents. The candidate translations are scored and a target query is output, based on the scores of the candidate translations.

U.S. Pub. No. 20130006954, published Jan. 3, 2013, entitled TRANSLATION SYSTEM ADAPTED FOR QUERY TRANSLATION VIA A RERANKING FRAMEWORK, by Vassilina Nikoulina and Nikolaos Lagos, discloses an apparatus and method adapted to cross language information retrieval using a machine translation system trained to provide good retrieval performance on queries translated with the system.

U.S. Pub. No. 20100070521, published Mar. 18, 2010, entitled QUERY TRANSLATION THROUGH DICTIONARY ADAPTATION, by Stephane Clinchant, et al., discloses cross-lingual information retrieval by translating a query and performing information retrieval using the translated query to retrieve a set of pseudo-feedback documents. The query is retranslated using a translation model derived from the set of pseudo-feedback documents.

### BRIEF DESCRIPTION

In accordance with one aspect of the exemplary embodiment, a method for cross language information retrieval includes receiving an input query which includes at least one word in a source language; and translating the input query from the source language to a target language to provide a set of translated queries. Documents are retrieved from a document collection based on the translated queries. The retrieved documents, in whole or in part, are translated into the source language to generate a set of translated documents. An entailment relationship between each of the translated documents and the input query is assessed. The set of translated documents is refined based on the assessment of the entailment relationship and at least a subset of the refined set of translated documents, and/or the target documents to which the translated documents in the subset correspond, is output.

One or more of the translating the input query, retrieving documents, translating the retrieved documents, assessing the entailment relationship, and refining the set of translated documents may be performed with a computer processor.

In accordance with another aspect of the exemplary embodiment, a system for cross language information retrieval includes a first machine translation component for translating an input query from a source language to a target language to provide a set of translated queries. A retrieval component retrieves documents from an associated document collection based on the translated queries. A second machine translation component translates the retrieved documents into the source language to generate a set of translated documents. An entailment component assesses an entailment relationship between each of the translated documents and the input query. A refinement component refines the set of translated documents based on the assessment of the entailment relationship. A processor implements the first and second machine translation components, retrieval component, entailment component, and refinement component.

In accordance with another aspect of the exemplary embodiment, a method for cross language information retrieval includes receiving an input query which includes at least one word in a source language, translating the input query from the source language to a target language to provide a set of translated queries, retrieving documents from a document collection based on the translated queries, and, optionally, translating the retrieved documents into the source language to generate a set of translated documents. The method further includes assessing an entailment relationship between each of the translated documents and the input query and/or between each of the untranslated retrieved documents and the input query and refining the set of translated or untranslated documents based on the assessment of the entailment relationship. The refining includes at least one of: retaining only those documents for which an entailment relationship is found and ranking the documents based on an entailment score. Provision is made for a user to review documents in the refined set of translated documents and/or corresponding untranslated documents.

One or more of the translating the input query, retrieving documents, assessing the entailment relationship, and refining the set of translated documents may be performed with a computer processor.

### BRIEF DESCRIPTION OF THE DRAWINGS

FIG. 1 is an overview, which illustrates aspects of the exemplary system and method;

FIG. 2 is a functional block diagram of a Cross Language Information Retrieval system in accordance with one aspect of the exemplary embodiment; and

FIG. 3 is a flow chart illustrating a Cross Language Information Retrieval method in accordance with another aspect of the exemplary embodiment.

### DETAILED DESCRIPTION

The exemplary embodiment relate to a system and method which refines the results of a Cross-Lingual Information Retrieval system (CLIR) by use of Textual Entailment (TE).

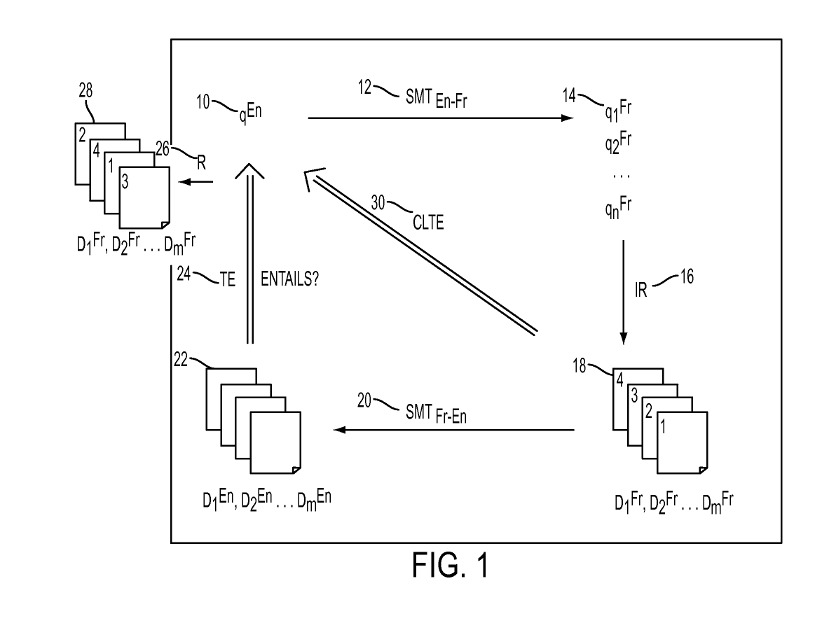

FIG. 1 summarizes the exemplary system and method. A textual query q^{En} 10 in a source language, such as English (En), is translated by a first statistical machine translation (SMT) component SMT_{En-F} 12. The output of the SMT component 12 is used to generate a set 14 of n-best translations q₁^{FR}, q₂^{FR}, q₃^{FR}, . . . , qₙ^{FR} of the query in a target language, such as French (Fr), i.e., a different language from the source language. The query translations 14 (singly or in combination) are used by an information retrieval (IR) component 16 to retrieve results in the form of a set 18 of responsive documents D₁^{FR}, D₂^{FR}, D₃^{FR}, . . . , Dₘ^{FR} in the target language. The responsive documents (or a selected part of each document), are then translated back to the source language with a second SMT component SMT_{Fr-En} 20 to produce a set 22 of documents D₁^{En}, D₂^{En}, D₃^{En}, . . . , Dₘ^{En} in the source language. A textual entailment (TE) component 24 applies textual entailment techniques to assess an entailment relationship between the input query q^{En} 10 and the translated documents D₁^{En}, D₂^{En}, D₃^{En}, . . . , Dₘ^{En}, which may include determining whether the input query q^{En} 10 is entailed by each of the translated documents D₁^{En}, D₂^{En}, D₃^{En}, . . . , Dₘ^{En}, or providing a score which is a measure of the entailment. The output of the textual entailment component 24 is used by a refinement component (R) 26 to refine the results 18, for example, by filtering out irrelevant (non-entailing) documents or re-ranking the documents to generate a refined set 28 of documents. The assumption is that relevant documents will contain at least one segment that entails the query. In another embodiment, a Cross-Lingual Textual Entailment (CLTE) component 30 can be used to compare the source query with the results 18, which collapses the translation and textual entailment assessment into a single step.

The system and method thus allow the SMT and IR components 12, 16, 20 to be each treated as a black box, i.e., they can be conventional components which do not need to be modified.

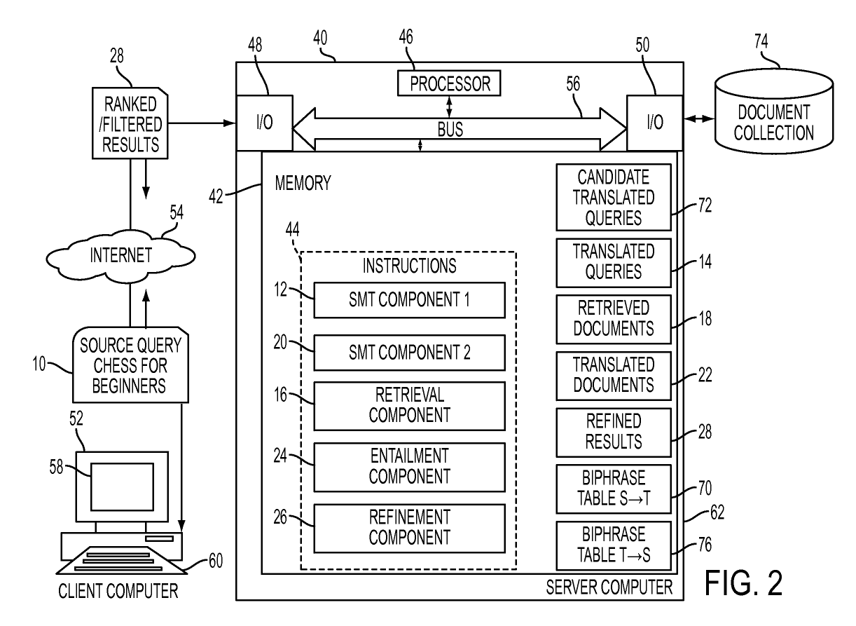

With reference to FIG. 2, an exemplary computer implemented system 40 for performing the method is illustrated. In the following discussion, s and t (rather than En and Fr) are used to represent the source and target languages, respectively. The system includes memory 42 which stores instructions 44 for performing the exemplary method and a processor 46 in communication with the memory which executes the instructions. One or more network interfaces 48, 50 are configured for communicatively connecting the system 40 with external devices, such as a source computing device 52 or other memory storage device, which provides the source language textual query 10. The device 52 is illustrated as a client computing device, which is communicatively connected with the system via a wired or wireless link 54, such as a local area network or wide area network, such as the Internet. Hardware components 42, 46, 48, 50 of the system are communicatively connected by a data/control bus 56.

The client device 52 includes a display device 58, such as an LCD or LED screen, computer monitor, or the like, and a user input device 60, such as a touch screen, keyboard, keypad, cursor control device, combination thereof or the like, for inputting a textual query 10, e.g., via a web browser. In the exemplary embodiment, the system 40 is hosted by a computing device 62, such as the illustrated server computer. In other embodiments the system 40 may be hosted, in whole or in part, by the client computing device 52.

The software instructions 44 include first and second machine translation components 12, 20, retrieval component 16, entailment component 24, and refinement component 26, as discussed for FIG. 1. The SMT component 12 may be a phrase-based machine translation system which receives, as input the source query 10 and accesses a first biphrase table 70 to retrieve a set of relevant biphrases (biphrases that each includes one or more words of the source query 10). Each of the biphrases in the table 70 includes a source phrase and a corresponding target phrase and an associated set of features, which may have been derived from a parallel corpus of documents in the source and target languages. The SMT component 12 uses a statistical model to identify relevant biphrases which in combination cover the source query and form a candidate target query from the target phrases of these biphrases. From a set 72 of such candidate target queries, the SMT component 12 generates the n-best list 14 of at most n translated queries. n may be a predefined number, e.g., a number from 5-100, which may be at least 10, or at least 20, or at least 50, or up to 100, and the SMT component 12 outputs up to the number n, or which equals n, provided that the SMT component 12 has generated at least this number of different candidate target queries 72. While the SMT component has been described in terms of a phrased-based system, it is to be appreciated that other machine translation systems may be employed.

The retrieval component 16 includes a search engine for querying an associated document collection 74 with each of the translated queries in the n-best list 14 individually, or with a single query based thereon, to retrieve a result set which includes a set 18 of up to m documents from the collection that are responsive to the queries/combination query, where m can be a predefined number, e.g., a number from 5-100, such as 5, 10, 20, 50 or 100. The retrieval component 16 may have its own rules for query expansion, filtering results, and so forth in order to identify the document set 18. The documents in the set may be ranked based on their relevance to the translated queries/combination query, but need not be. In general, the documents in the collection 74 are in the target language, although it is also contemplated that a few of the documents or parts of documents may be in other languages. The documents in the collection may include web pages, text documents, OCRed pdf documents, combinations thereof, and the like.

The second SMT component 20 translates each of the retrieved documents, or a respective part thereof, into the source language. The SMT component 20 may be similarly configured to the first SMT component, accessing a phrase table 76 to retrieve relevant biphrases and from these using a probabilistic model to build a source language sentence for each sentence of the respective document or document part. Here, however, the aim is not to identify a number of candidate translations, but rather to generate a single translation for each document in the set 18. In other embodiments, an n-best list of candidate translations could be used. The TE component 24 receives as input the translated documents 22 (or relevant parts thereof) and treating the original query 10 as a textual entailment Hypothesis, determines whether one or more sentences in the text of the translated document entails the query 10 using, for example, a set of entailment rules. The TE component 24 outputs an entailment decision for the translated document as a whole, or a translated part thereof, based on the entailment found, if any. The entailment decision may be binary or in the form of a score. When multiple segments of a single document are assessed with respect to the hypotheses, the decision may be made as follows: if binary entailment is used, the document is retained if at least one of the segments is found to entail the query; if a numeric score is used, then, for instance, the maximal score of all segments may be used as the entailment score of the entire document.

The refinement component 26 ranks, filters, and/or otherwise refines the result set based on the output of the TE component 24.

The computer system 40 may be a PC, such as a desktop, a laptop, palmtop computer, portable digital assistant (PDA), server computer, cellular telephone, tablet computer, pager, combination thereof, or other computing device capable of executing instructions for performing the exemplary method.

The memory 42 may represent any type of non-transitory computer readable medium such as random access memory (RAM), read only memory (ROM), magnetic disk or tape, optical disk, flash memory, or holographic memory. In one embodiment, the memory 42 comprises a combination of random access memory and read only memory. In some embodiments, the processor 46 and memory 42 may be combined in a single chip. The network interface 48, 50 allows the computer to communicate with other devices via a computer network, such as a local area network (LAN) or wide area network (WAN), or the internet, and may comprise a modulator/demodulator (MODEM). Memory 42 stores instructions for performing the exemplary method as well as the processed data.

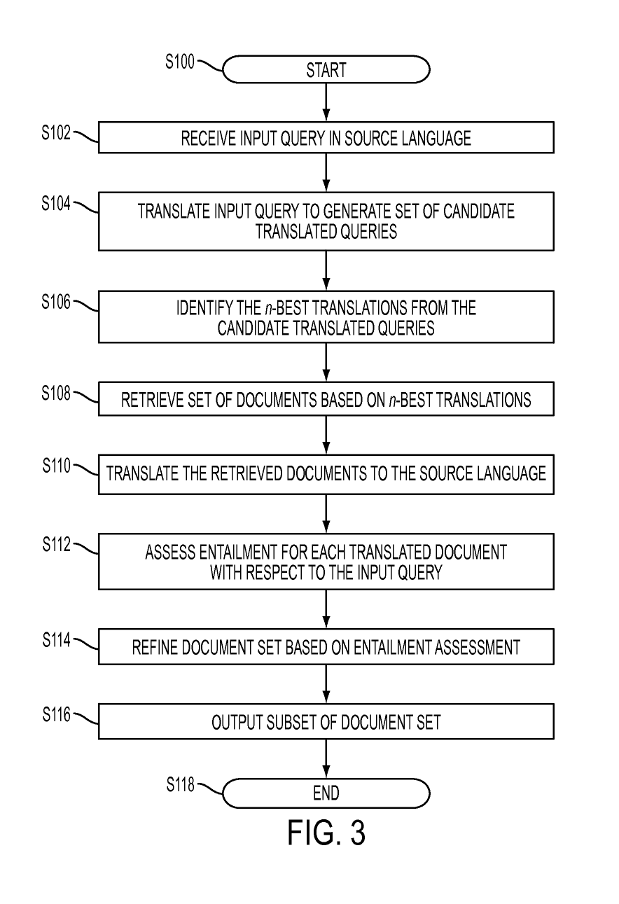

The digital processor 46 can be variously embodied, such as by a single-core processor, a dual-core processor (or more generally by a multiple-core processor), a digital processor and cooperating math coprocessor, a digital controller, or the like. The digital processor 46, in addition to controlling the operation of the computer 62, executes instructions stored in memory 42 for performing the method outlined in FIG. 3.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

As will be appreciated, FIG. 2 is a high level functional block diagram of only a portion of the components which are incorporated into a computer system 40. Since the configuration and operation of programmable computers are well known, they will not be described further.

With reference now to FIG. 3, the exemplary method starts at S100.

At S102, a query q^{s} is received which includes one or more words in the source language s (En in FIG. 1).

At S104, the input query q^{s} is translated by the first SMT component 12 from the source language to the target language t (Fr in FIG. 1) to provide a set of candidate translations 72.

At S106, the n-best translations of q^{s} in the target language t, {q₁^{t} . . . qₙ^{t}} are identified from the candidate translated queries. As will be appreciated, steps S104 and S106 can be collapsed into a single step which outputs the n-best translated queries 14.

At S108, at most m documents {D₁^{t} . . . Dₘ^{t}} are retrieved from the document collection D 74 by the IR component 16, based on the translated queries 14 generated in S106.

At S110, the documents 18 retrieved at S108 are translated to the source language s, by the second SMT component 20, to form a set 22 of translated documents {D₁^{s} . . . Dₘ^{s}}.

At S112, the entailment relationship between each translated document {D₁^{s} . . . Dₘ^{s}} and the original query q^{s} is assessed by the TE component 24.

At S114, the set of results 22 is refined, for example, by retaining only those documents in the translated source language set {D₁^{s} . . . Dₘ^{s}} (and/or the corresponding ones of the documents in the target language {D₁^{t} . . . Dₘ^{t}}) for which entailment holds or by ranking the documents based on an entailment score. This may include reranking the documents, if the documents have already been ranked by the retrieval component.

At S116, the refined results 28 generated at S114, or a subset of them, are output. This may include displaying relevant parts of the most highly ranked documents in the target language and/or translated into the source language. The part of the document which led to an identification of a textual entailment relationship may be highlighted, for example, using a different font, bold, italic, a bounding box, a highlighting color, or the like. The results may be displayed in a graphical user interface, e.g., generated by the system for display on the display device 58, which allows the user to review the entire document, e.g., translated to the source language, when clicking on the displayed result. As will be appreciated, in some, but not all cases, the set of results 22 and/or refined subset 28 may be an empty set.

The method ends at S118.

The method illustrated in FIG. 3 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 3, can be used to implement the method.

Further details of the system and method will now be described.

The process starts once the user has typed in a query 10 in the source language. In general, queries are short, such as from 1-10 words, and may lack some of the proper grammar normally expected for the source language. The query 10 is translated into the target language and the top-n translations, as ranked by the SMT system, are obtained. The multiple translations can be used to generate a single query in the target language. Various methods for generating such a combination query are contemplated. In one method, the unique terms from the translated queries 14 are concatenated. Concatenated terms can have equal weights or be weighted according to the number of occurrences of the word in the different translated queries. As a result, words that were consistently translated over the translated queries 14 are assigned a higher weight. In another method, a disjunctive clause is used (with OR between the different translations). The first option merges all possible translated queries, and thus is only useful in lexical retrieval, i.e., word-based. The second option keeps the different translations separated, thus can also be used to match the entire translation in the retrieved document, potentially obtaining more accurate results. In practice, a simple concatenation is a reasonably effective way to create the combination queries.

Up to m top documents as matched by the IR component 16 are then retrieved. Since the TE component 24 provides a semantic verification to the workflow, allowing removal of some of the retrieved documents (in the filtering option), n and m can be set higher than what would be the default values of a conventional CLIR system for translations and retrieved documents, respectively.

### Translation (S104, S110) and Scoring of Candidate Queries (S106)

When translating from the source to the target language (or vice versa), the respective biphrase table 70, 76 is accessed to retrieve a set of biphrases, each of which includes a target phrase which matches part of a source sentence or other text string to be decoded. Traditional approaches to phrase-based machine translation use dynamic programming to search for a derivation (or phrase alignment) that achieves a maximum probability (or score), given the source sentence, using a subset of the retrieved biphrases. Typically, the scoring model attempts to maximize a log-linear combination of the features associated with the biphrases used. Biphrases are not allowed to overlap each other, i.e., no word in the source and target sentences of an alignment can be covered by more than one biphrase.

Phrase based machine translation systems suitable for use as SMT components 12, 20 are disclosed, for example, in U.S. Pat. No. 6,182,026 entitled METHOD AND DEVICE FOR TRANSLATING A SOURCE TEXT INTO A TARGET USING MODELING AND DYNAMIC PROGRAMMING, by Tillmann, et al., U.S. Pub. No. 20040024581 entitled STATISTICAL MACHINE TRANSLATION, by Koehn, et al., U.S. Pub. No. 20040030551 entitled PHRASE TO PHRASE JOINT PROBABILITY MODEL FOR STATISTICAL MACHINE TRANSLATION, by Marcu, et al., U.S. Pub. No. 20080300857, entitled METHOD FOR ALIGNING SENTENCES AT THE WORD LEVEL ENFORCING SELECTIVE CONTIGUITY CONSTRAINTS, by Madalina Barbaiani, et al.; U.S. Pub. No. 20060190241, entitled APPARATUS AND METHODS FOR ALIGNING WORDS IN BILINGUAL SENTENCES, by Cyril Goutte, et al.; U.S. Pub. No. 20070150257, entitled MACHINE TRANSLATION USING NON-CONTIGUOUS FRAGMENTS OF TEXT, by Nicola Cancedda, et al.; U.S. Pub. No. 20070265825, entitled MACHINE TRANSLATION USING ELASTIC CHUNKS, by Nicola Cancedda, et al.; U.S. Pub. No. 20120101804, entitled MACHINE TRANSLATION USING OVERLAPPING BIPHRASE ALIGNMENTS AND SAMPLING, by Benjamin Roth, et al.; U.S. Pub. No. 20110307245, entitled WORD ALIGNMENT METHOD AND SYSTEM FOR IMPROVED VOCABULARY COVERAGE IN STATISTICAL MACHINE TRANSLATION, by Gregory Hanneman, et al.; and U.S. Pub. No. 20130006954, entitled TRANSLATION SYSTEM ADAPTED FOR QUERY TRANSLATION VIA A RERANKING FRAMEWORK, by Vassilina Nikoulina, et al., the disclosures of which are incorporated herein by reference in their entireties However, other machine translation systems are also contemplated, such as rule based, dictionary based, transfer-based, or hybrid machine translation systems, which can be used alone or in combination with an SMT system.

An example statistical machine translation component 12, 20 is a Moses phrase-based SMT system. See, Philipp Koehn, et al., “Moses: open source toolkit for statistical machine translation,” ACL '07: Proc. 45th Annual Meeting of the ACL on Interactive Poster and Demonstration Sessions, pp. 177-180 (ACL, 2007).

Methods for building libraries of parallel corpora from which bilingual phrase tables 70, 76 can be generated are disclosed, for example, in U.S. Pat. No. 7,949,514, entitled METHOD FOR BUILDING PARALLEL CORPORA, by Francois Pacull; U.S. Pub. No. 20100268527, entitled BI-PHRASE FILTERING FOR STATISTICAL MACHINE TRANSLATION, by Nadi Tomeh, et al., the disclosures of which are incorporated herein by reference in their entireties. Each biphrase table 70, 76 is a probabilistic dictionary associating short sequences of words in two languages that can be considered to be translation pairs.

Methods for scoring machine translations which can be used herein by the SMT component 12 to generate the n-best list 14 are disclosed, for example, in U.S. Pub. No. 20050137854, entitled METHOD AND APPARATUS FOR EVALUATING MACHINE TRANSLATION QUALITY, by Nicola Cancedda, et al., and U.S. Pat. No. 6,917,936, entitled METHOD AND APPARATUS FOR MEASURING SIMILARITY BETWEEN DOCUMENTS, by Nicola Cancedda; and U.S. Pub. No. 20090175545 entitled METHOD FOR COMPUTING SIMILARITY BETWEEN TEXT SPANS USING FACTORED WORD SEQUENCE KERNELS, by Nicola Cancedda, et al, the disclosures of which are incorporated herein by reference in their entireties. An example scoring method is the BLEU score for assessing the quality of the translations output by the Moses phrase-based SMT system. For further details on the BLEU scoring algorithm, see, Papineni, K., Roukos, S., Ward, T., and Zhu, W. J., “BLEU: a method for automatic evaluation of machine translation,” ACL-2002: 40th Annual meeting of the Association for Computational Linguistics, pp. 311-318 (2002). Another objective function which may be used as the translation scoring metric is the NIST score. See, Doddington, G., “Automatic Evaluation of Machine Translation Quality Using N-gram Co-Occurrence Statistics,” HLT '02 Proc. 2nd Intern'l Conf. on Human Language Technology Research, pp. 138-145 (2002).

In the case of the translation of documents in set 18, the translation component 20 may translate the entire document, or only a part of the document, such as only the first P paragraphs, where P may be a predetermined number, such as a number from 1-5, only the first Q words, where Q may be a predetermined number, such as a number from 100-500, or only the paragraph(s) (as for P) where text identified as responsive to the query was found. In either case, the user may be provided with the entire document in translated form when the user requests to review it in S116.

### Information Retrieval (S108)

The information retrieval step seeks to find relevant information, or relevant documents containing such information, within a large corpus (e.g., a large database of documents or the Web). One of the difficulties in IR is related to the multiple representations of a meaning. A document and a query are represented by terms that occur in them, which can be different, even though they describe the same meaning. This makes it difficult to match the relevant documents against a query. The representation problem is even more evident in cross-language information retrieval (CLIR) or multi-language information retrieval (MLIR), where queries and documents are described in different languages.

In the present system, this is addressed by expanding the coverage of the search, e.g., expansion with n-best translations as given by the SMT system 12 (expansion with synonyms, either from a dictionary or other resources, may be used in some embodiments). Such approaches tend to find a bigger fraction of the relevant documents (improving recall) but also retrieve more irrelevant documents (with the possibility of harming precision). By applying TE as a post-retrieval step in such a setting, precision can be improved without appreciable loss of recall.

### Assessment of Textual Entailment (S112)

In the entailment assessment step, the query is considered as the entailment Hypothesis H, and a retrieved document translation (or segment thereof) as the Text T. An assessment is made whether T entails H. In one embodiment, Text T is considered relevant only if T entails H (a binary decision). If it does not, the document may be removed from the list of retrieved documents 22. In another embodiment, an entailment score is computed by the TE component and documents can be ranked (or reranked) based on their entailment scores in order to place documents that are more likely to be relevant higher on the list. The textual entailment step thus serves as a post-retrieval filtering sand/or reranking step, based on Semantic Inference that considers the retrieved documents and confronts them with the original query.

The underlying assumption is that a relevant document semantically implies the Hypothesis. Dealing with complete documents may be a difficult task for current entailment systems. In one embodiment, candidate segments of the document are first identified before assessing entailment. This is based on the assumption that every relevant document contains at least one text segment (e.g., a sentence or paragraph) that entails the Hypothesis. The candidate text segments in the documents can be identified, for example, by partial keyword matching, as has been suggested for entailment search tasks (see, Shachar Mirkin, et al., “Recognising entailment within discourse,” Proc. 23rd Intern'l Conf. on Computational Linguistics (Coling 2010), pp. 770-778 (2010); Luisa Bentivogli, et al., “The sixth PASCAL recognizing textual entailment challenge,” Proc. Text Analysis Conference (TAC) (2010)). For example, the system may identify text segments of the retrieved documents where one or more of the words in one of the translated queries (or IR query) are found (which may exclude common words that are found in many text segments) and translate these candidate text segments, rather than the entire document.

In other embodiments, the entailment component 24 may use only a predetermined part of the translated document for the evaluation, such as only the first P′ sentences or paragraphs, where P′ may be a predetermined number, such as a number from 1-5, only the first Q′ words, where Q′ may be a predetermined number, such as a number from 100-500, or only the sentences/paragraph(s) (as for P′) where text identified as responsive to the query was found.

Each of the candidate text segments may be translated back to the source language. The translated portions of the documents are then assessed by the textual entailment component. Two options are contemplated. One is to use the entailment system in binary mode, i.e. to use its true or false decision as a hard constraint and remove from the list 22 of retrieved documents the ones for which the answer is false (no entailment). A threshold for this decision is tunable. A second option is to rerank the documents based on the TE score (optionally, combining it with the IR score output by the IR component 16).

The second translation step is beneficial because entailment assessment cannot be performed effectively on the translated query, as it is the result of the combination of multiple translations, rather than a single assertion or phrase.

In some embodiments the entailment can be performed directly on the target side: the target document is assessed with each of a set of the translated queries separately and a decision is made that entailment holds if at least one of them is found to be entailed. This is a less efficient solution, but it may be useful in some situations, e.g., when the query translation model 12 performs well, but the document translation model 20 does not, or when a target language TE system works better than the source-language TE system 24. Cross-language TE can also be applied directly between the candidate retrieved documents in the target language and the source query.

Such an application of semantic inference allows improving CLIR performance, especially in recall-oriented situations. Since the IR query may be derived from a larger number n of translations than in a conventional system, retrieval is more likely to cover a wider range of documents, but unavoidably also introduces more non-relevant ones into the retrieved document set. The additional TE step serves to identify only the more relevant ones among them.

An advantage of the system and method is that it can be performed on top of a black-box IR system. Many content providers are not willing to change existing document indexing and search tools, or to provide access to their document collection by a third-party external service. Thus, the document retrieval step (S108) may be delegated to a separate computing device and the system 40 may have no direct access to the entire document collection 74, only to the retrieved documents 18. In some embodiments, the query translation component 12 allows translating input queries into several target languages without changing the underlying IR system 16. Similarly, the TE component 24 used in the exemplary system and method, which operates as a post-retrieval step, allows using an existing IR system without modifying it, and when combined with the query translation provides an external solution for improving the performance of CLIR.

As will be appreciated, the translation of the target document into the source language (S110) may introduce errors arising from incorrect translation. However, a difference between the two translation steps that take place in the method is that the translation of the document can be achieved with much more context than the translation of the query (since documents are generally much longer than the query), which allows the SMT system 12 to perform better. The translation does not need to be a perfect translation of the document; only good enough to enable an accurate decision from the TE system 24.

Methods for identifying and utilizing textual entailment which may be used herein are described in U.S. application Ser. No. 13/920,462, filed Jun. 18, 2013, entitled COMBINING TEMPORAL PROCESSING AND TEXTUAL ENTAILMENT TO DETECT TEMPORALLY ANCHORED EVENTS, by Caroline Hagège, et al., U.S. Pub. No. 20110276322, published Nov. 10, 2011, entitled TEXTUAL ENTAILMENT METHOD FOR LINKING TEXT OF AN ABSTRACT TO TEXT IN THE MAIN BODY OF A DOCUMENT, by Agnes Sandor, et al., U.S. Pub. No. 20070255555, published Nov. 1, 2007, entitled SYSTEMS AND METHODS FOR DETECTING ENTAILMENT AND CONTRADICTION, by Richard S. Crouch, et al.; Ido Dagan, et al., “Recognizing textual entailment: Rational, evaluation and approaches,” Natural Language Engineering, pages 15(4):1-17 (2009; A Harabagiu and Andrew Hickl, “Methods for using textual entailment in open domain question answering,” Proc. ACL 2006, pp. 905-912, 2006), the disclosures of which are incorporated herein by reference in their entireties.

The textual entailment relation was originally defined in terms of truth values. That is, TE holds if T is true implies that H is true, at least in most cases (see, Ido Dagan and Oren Glickman, “Probabilistic textual entailment: Generic applied modeling of language variability,” PASCAL Workshop on Learning Methods for Text Understanding and Mining, Grenoble, France, 2004). Later, this narrow definition was extended to sub-sentential assertions for which truth values cannot be applied. These expansions make TE formally applicable to words and phrases, and consequently make it relevant for IR, where queries are typically sub-sentential phrases rather than complete sentences. See, for example, Oren Glickman, et al., “Lexical reference: a semantic matching subtask,” Proc. EMNLP (2006) and Shachar Mirkin, et al., “Evaluating the inferential utility of lexical-semantic resources,” Proc. 12th Conf. of the European Chapter of the ACL (EACL 2009), pp. 558-566 (2009). Association for Computational Linguistics). The exemplary system thus utilizes a more expansive view of textual entailment.

In the present method, Textual Entailment (TE) evaluates: can the meaning of one text (denoted H) be inferred from another (denoted T). When such a relation holds, then it is stated that T textually entails H. Paraphrases are a special case of the entailment relation, where the two texts both entail each other. The notions of simplification and of generalization can also be captured within TE, where the meaning of the simplified or the generalized text is entailed by the meaning of the original text (see, Mirkin, S., PhD thesis, “Context and Discourse in Textual Entailment Inference,” Bar-Ilan University (2011). In the present case, TE can be used to recognize both paraphrases (which preserve the meaning) and simplification or generalization operations (which preserve the core meaning, but may lose some information) with entailment-based methods.

The exemplary textual entailment method may employ rules that loosen the strict definition of entailment used in formal semantics, where an entailment relation is defined as the following:

A entails B if:

Whenever A is true, B is true

The information that B conveys is contained in the information that A conveys

A situation describable by A must also be a situation describable by B

A and not B is contradictory (can't be true in any situation).

Under the more flexible definition, Textual Entailment may be defined as a directional relationship between pairs of text expressions in which T entails H if, typically, a human reading T would infer that H is most likely true (see, Dagan, I., et al., “The PASCAL Recognising Textual Entailment Challenge,” Lecture Notes in Computer Science, 3944, pp. 177-190, Springer-Verlag, 2006). Here, the entailing “Text” T is the translated document segment, and the entailed “Hypothesis” H is the query.

In the exemplary textual entailment step, pairs of extracts (query and translated document sentence) are compared and the textual entailment component 24 detects if the sentence entails the query. For each pair of extracts that is determined to be in an entailment relationship, therefore, one of the extracts (the query) is identified as the entailing extract and the other as the entailed (i.e., which can be inferred from the entailing extract). In the exemplary embodiment, the entire sentence in which a text except responsive to the IR query has been found may be considered when looking for entailment relationships. However, it is also contemplated that a shorter string, containing the text segment, which is less than the entire sentence, may be considered.

For recognition of entailment, the textual entailment component 24 may employ a large set of entailment rules, including lexical rules that correspond to synonymy (e.g., ‘buy→acquire’), meronymy (‘is a part of’ relationships, e.g., finger→hand) and hypernymy (‘is a type of’ relations like ‘poodle→dog’), lexical syntactic rules that capture relations between pairs of predicate-argument tuples, and syntactic rules that operate on syntactic constructs. For example, the textual entailment rules which implement this more flexible approach may include some or all of the following:

Rules which allow an uncertainty to be considered equivalent to an absolute value, e.g.:
Z is about (or approximately, perhaps, may be) X entails: Z is X, or Z is X±Y, or Z is X±Y % of X.

Under this rule, John is about 30 could entail each of the following strings: John is 30 and John is 29.

Rules which consider categories of named entities, e.g.:

Named Entity X entails Title or Role of Named entity

In some synonym-related entailment rules, common nouns, verbs and other parts of speech may be considered equivalent to respective stored synonyms. Under such rules, Abraham Lincoln was hurt could entail each of the following strings: The President was hurt, The President was wounded, given a rule that associates Abraham Lincoln with the title of President and another rule which recognizes synonymy between the verbs hurt and wound.

Coreference resolution may also be used to analyze surrounding text in the same or sentence or document to identify persons corresponding to pronouns. Under such processing, John is about 30, may entail He is under 40, for example, if the previous sentence refers to John as the subject.

As will be appreciated, contextual and other requirements may also be applied to limit the equivalents which are permitted for an entailment to be found.

Prior to applying the entailment rules, each translated document or segment of the document (and the input query itself) may first be parsed to identify syntactic dependencies in the translated document/segment which are relevant to the entailment rules being applied, for example, to identify parts of speech, such as nouns, verbs, adjectives, etc., and then to identify elements such as the argument of each verb. The following disclose a parser for syntactically analyzing an input text string in which the parser applies a plurality of rules which describe syntactic properties of the language of the input text string: U.S. Pat. No. 7,058,567, entitled NATURAL LANGUAGE PARSER, by Aït-Mokhtar, et al., and Aït-Mokhtar, et al., “Robustness beyond Shallowness: Incremental Dependency Parsing,” Special Issue of NLE Journal (2002). Similar incremental parsers are described in Aït-Mokhtar “Incremental Finite-State Parsing,” in Proc. 5th Conf. on Applied Natural Language Processing (ANLP '97), pp. 72-79 (1997), and Aït-Mokhtar, et al., “Subject and Object Dependency Extraction Using Finite-State Transducers,” in Proc. 35th Conf. of the Association for Computational Linguistics (ACL '97) Workshop on Information Extraction and the Building of Lexical Semantic Resources for NLP Applications, pp. 71-77 (1997), the disclosures of which are incorporated herein by reference. The syntactic analysis may include the construction of a set of syntactic relations (dependencies) from an input text by application of a set of parser rules. Exemplary methods are developed from dependency grammars, as described, for example, in Mel'c\check{u}k I., “Dependency Syntax,” State University of New York, Albany (1988) and in Tesnière L., “Elements de Syntaxe Structurale” (1959) Klincksiek Eds. (Corrected edition, Paris 1969).

Existing textual entailment systems which may be useful herein singly or in combination include multiple semantic processing components, such as one or more of lexical matching, syntactic matching, referent matching, and semantic matching (see, Cabrio et al., “Combining specialized entailment engines for RTE-4,” Proc. TAC-2008).

Lexical matching aims to identify single words or expressions which have the same or entailed meaning. An external resource may be used to measure lexical similarities between tokens from the query text segment and a candidate entailing text segment from the document. One such lexical resource is WordNet™. For example, a similarity score based on the WordNet Path between two tokens may be determined (see, for example, Hirst, et al., “Lexical chains as representations of context for the detection and correction of malapropisms,” in Fellbaum 1998, pp. 305-332). Another kind of similarity measure which can be used in evaluating textual entailment is the lexical entailment probability. This probability is estimated by taking the page counts returned from a search engine for a combined u and v search term, and dividing it by the count for just the v term. (See, for example, Glickman et al., “Web based probabilistic textual entailment,” in Quinonero-Candela, et al., Eds, MLCW 2005, LNAI, Volume 3944, pp. 287-298, Springer-Verlag, 2006).

Syntactic matching may be found when two text elements occurring in both of the text segments serve the same roles in a syntactic dependency, e.g., are both arguments of a respective predicate (e.g., A bought B entails B was acquired by A). In such cases, the text segment of the document (or query) may be converted from active to passive voice or vice versa, as part of the entailment recognition process. Syntactic matching is described, for example, in Adams, et al., “Textual Entailment Through Extended Lexical Overlap and Lexico-Semantic Matching,” Proc. ACL-PASCAL Workshop on Textual and Entailment and Paraphrasing, pp. 119-124, 2007; and Hickl, et al., “Recognizing Textual Entailment with LCC's Groundhog System,” Proc. 2nd PASCAL Challenges Workshop, 2006, “Hickl, et al. '06”). For referent matching, which uses coreference resolution to identify two expressions which refer to the same entity but using different terms, see, Hickl, et al. '06 and U.S. Pub. No. 20090204596, incorporated by reference. Semantic matching involves operations such as recognizing negation and antonyms in a sentence and is described, for example, in Cabrio et al., “Combining specialized entailment engines for RTE-4,” Proc. TAC-2008.

See, for example, U.S. Pub. No. 20110276322, published Nov. 10, 2011, entitled TEXTUAL ENTAILMENT METHOD FOR LINKING TEXT OF AN ABSTRACT TO TEXT IN THE MAIN BODY OF A DOCUMENT, by Ågnes Sandor and Guillaume Jacquet, the disclosure of which is incorporated herein in its entirety by reference, for a detailed description of these and other kinds of matching which may be used by the textual entailment component in identifying pairs of text segments that are in an entailment relationship.

As an example of an entailed relationship in the present system, the query:

chess for beginners may be found to be entailed by the more general sentence in one of the retrieved documents:

The board games for novices book was published in 1842.

An example of an existing TE system suited to use herein is the open source Bar Ilan University Textual Entailment Engine (BIUTEE), described in Stern and Dagan, “A Confidence Model for Syntactically-Motivated Entailment Proofs,” Proc. RANLP 2011, pp. 455-462, and Stern and Dagan, “BIUTEE: A modular open-source system for recognizing textual entailment,” Proc. ACL 2012 System Demonstrations, pp. 73-78, ACL 2012 (available at www.cs.biu.ac.il/~nlp/downloads/biutee).

In other embodiments, the input query is first expanded with entailing terms prior to assessing entailment of the translated document, and then search with the expanded query. In another embodiment, an extended similarity measure is computed between documents and queries that includes or is based on a set of TE measures. See, for example, Stéphane Clinchant, Cyril Goutte, and Eric Gaussier, “Lexical entailment for information retrieval,” Lecture Notes in Computer Science, pp. 217-228 (Springer, 2006). A combination of the approaches can be used.

Without intending to limit the scope of the exemplary embodiment, the following examples demonstrate the applicability of the method.

### Examples

In the present experiments, English was used as the source language (the language of the original query) and French as the target language (the language of the searched corpus).

Experiments were performed using the CLEF TEL 2009 document collection. This was developed for evaluation of monolingual and cross-language search on library catalogs (See, Nicola Ferro and Carol Peters, “Clef 2009 ad hoc track overview: Tel and Persian tasks,” in Carol Peters, et al., Eds, Multilingual Information Access Evaluation I. Text Retrieval Experiments, volume 6241 of Lecture Notes in Computer Science, pages 13-35 (2010), hereinafter “Ferro 2010”). The task organizers have made available documents in English, French and German. The French dataset used in the present experiments comes from the National Library of France and includes 1,000,100 documents (called “Bibliothéque Nationale de France” (BNF) corpus).

The TEL CLEF collection includes documents, topics and relevance assessments. Topics represent a search request and include a title that summarizes the request (e.g. Deep Sea Creatures), a description, and a narrative. Only the title was used for the present evaluation, as its style is closer to typical user queries. Data in the documents of the BNF dataset tend to be very sparse. Many records contain only title, author and subject heading information; only some of the records provide more details. In addition, the title and (if existing) the description may be in a different language from what is assumed to be the language of the collection (Ferro 2010).

In this work, only the titles of the documents and the description field, when available, were indexed and thus available for IR searching. Most of the titles are one line texts while the descriptions (where available) are only a couple of lines long in the majority of the cases. A typical example of a document in the French collection is shown below.

<dc:title>Les mariages de Paris/par Edmond About</dc:title>

<dc:creator>About, Edmond (1828-1885)</dc:creator>

<dc:publisher>W. Gerhard (Paris)</dc:publisher>

<dc:date>1856</dc:date>

<dc:description>Comprend: Blondine</dc:description>

<dc:language>fre</dc:language>

<dc:type xml:lang=“fre”>texte imprimé</dc:type>

<dc:type xml:lang=“eng”>printed text</dc:type>

<dc:type xml:lang=“eng”>text</dc:type>

This dataset was selected for the experiments as it primarily contains single sentence documents. This facilitated evaluation of the method without dealing with performance issues or candidate segment selection. Thus, there was no need to be selective in the translation of the document. The approach was simply to translate the entire retrieved text and subsequently let it be assessed by the TE system. In practice this dataset was challenging, since its texts are not always coherent.

The search engine used is based on the Lucene library, a cross-platform text search engine built by the Apache Foundation (see, http://lucene.apache.org/core/).

To index the text, a Lucene analyzer was used. The analyzer is a dedicated Lucene component that builds, by applying a chain of transformations, a stream of tokens from a raw text input. The analyzer used here, the French Analyzer, contains the following components: item elision filter (for example, l'avion is tokenized as avion); lowercasing; stop-word removal, with Lucene's default French stop-word list; and a French light stemmer, implementing the UniNE algorithm (see, Jacques Savoy, “Light stemming approaches for the French, Portuguese, German and Hungarian languages,” Hisham Haddad, editor, SAC, pp. 1031-1035 (ACM, 2006).

Retrieval was performed by processing the query with the French Analyzer (another option is to use their lemmas).

For the SMT components 12, 20, two phrase-based SMT (PBMT) models for translation were used, implemented using the SMT toolkit Moses (see Philipp Koehn, et al., “Moses: open source toolkit for statistical machine translation,” ACL '07: Proc. 45th Annual Meeting of the ACL on Interactive Poster and Demonstration Sessions, pp. 177-180 (2007)). The first SMT component 12 uses an SMT model generated using the Europarl parallel corpus (Philipp Koehn, “Europarl: A multilingual corpus for evaluation of machine translation,” MT Summit, 2005). The second SMT component 20 uses an SMT model which is an enriched version of the first one that also integrates multi-language dictionaries; a Moses SMT server was used to make the translations, as described in F. Segond, et al., “From scarcity to bounty: how Galateas can turn your scarce short queries into gold,” LREC 2012 Workshop on Creating Cross-language Resources for Disconnected Languages and Styles (May 2012).

For the TE system 24, the BIUTEE system described above was used. As entailment knowledge resources, a set of generic syntactic rules was used and WordNet 3.0 was used for providing semantic relations including hyponymy and meronymy (see, Christiane Fellbaum, editor, “WordNet: An Electronic Lexical Database (Language, Speech, and Communication),” The MIT Press (1998)). The BIUTEE TE system 24 was trained on the RTE-2 dataset described in Roy Bar-Haim, et al., “The Second Pascal Recognising Textual Entailment Challenge,” Proc. Second PASCAL Challenge Workshop for Recognising Textual Entailment (2006). This dataset includes an annotated set of sentences pairs where the labels indicate whether there is entailment or not.

In the method (performed as described above), the Moses SMT component 12 was used to translate the query from English to French and obtain the 10-best translations. The French IR query was generated by concatenating all the translations, making sure that each token occurs only once in the resulting query. No term-weighting was applied to the queries. Using the final query in French, a search was launched using Lucene and the 100 top documents in French were obtained, if as many were matched. At this step, a baseline in terms of mean average precision (MAP) score is calculated (corresponding to a CLIR system without the exemplary TE component). Then, each of the documents was translated to English and the textual entailment component was applied. Based on the scores that were output by the TE component, the documents were ranked to obtain a final ranking.

The TE and ranking parts were run twice. In the first run (SMT+TE), none of the components were optimized or tuned for the task. Further improvements to the SMT or TE components can lead to improved results. For example, in the second run (SMT−dict+TE), an improved version of the document SMT model was created by enriching the training data with multi-language dictionaries. Results are shown in TABLE 1.

TABLE 1
Results

| Run | MAP score |
|---|---|
| baseline | 0.0639 |
| SMT + TE | 0.065 |
| SMT-dict + TE | 0.0678 |

Although the baseline is lower than in can be achieved in existing CLIR (as the pre-processing was not optimized and pseudo-relevance feedback was not employed), an overall relative improvement of 6.1% in terms of MAP score was achieved with the present method, when compared to the baseline. Further, when using an improved MT model (SMT−dict+TE), compared to the default one, an additional relative improvement of 4% is achieved. By comparison, existing methods for performing this task perform poorly.

These results suggest that applying a post-retrieval semantic step is better than a simple word similarity algorithm that operates just on the surface of the tokens. This is illustrated by a substantial improvement in the MAP score of the query “plant diseases,” of about 9% (0.3962 with the baseline vs. 0.4349 with the run SMT+TE). In this specific case, the TE system 24 scored documents with the “factory” meaning of “plant” (e.g., Renault plant of Orleans) relatively low.

The exemplary method described herein is especially applicable for recall-oriented tasks, with a noted improvement in CLIR on the CLEF TEL 2009 collection in comparison to the baseline IR system. We have implemented a first workflow illustrating the feasibility of the approach. Using TE to improve precision can thus be used in combination with query expansion approaches to achieve better IR results in a complementary fashion.

It is anticipated that the results of the method can be improved by training and tuning the SMT and TE systems on data that is more similar to the test set. Here, the Europarl corpus used for training the SMT system is quite different from the type of queries and documents that were used in retrieval. Additionally, the ranking could be improved by considering both the IR and entailment scores. A hard constraint could also be introduced where document that are considered non-relevant by the TE system are removed, e.g., removing documents that are below a threshold TE score.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for cross language information retrieval comprising:
receiving an input query which includes at least one word in a source language;
translating the input query from the source language to a target language to provide a set of translated queries;
retrieving documents from a document collection based on the translated queries;
translating at least a part of the retrieved documents into the source language to generate a set of translated documents;
assessing an entailment relationship between each of the translated documents and the input query;
refining the set of translated documents based on the assessment of the entailment relationship; and
outputting at least a subset of the refined set of translated documents or the target documents to which the translated documents in the subset correspond;
wherein at least one of the translating the input query, retrieving documents, translating the retrieved documents, assessing the entailment relationship, and refining the set of translated documents is performed with a computer processor.

2. The method of claim 1, wherein the refining of the set of translated documents comprises at least one of:
retaining only those translated documents for which entailment is found; and
ranking the translated documents based on an entailment score.

3. The method of claim 2, wherein the refining comprises removing documents from the set of translated documents that do not meet a threshold entailment score and ranking the remaining documents based on an entailment score.

4. The method of claim 3, wherein the ranking of the documents is also based on a retrieval score for the corresponding retrieved documents.

5. The method of claim 1, wherein the outputting at least a subset of the refined set of translated documents comprises displaying a part of at least some of the documents which led to a finding of textual entailment.

6. The method of claim 1, wherein the translating the input query from the source language to a target language comprises translating the input query to generate a set of candidate translations and from the candidate translations identifying a subset of the best candidate translations as the set of translated queries.

7. The method of claim 1, wherein the assessing of the entailment relationship comprises applying a set of textual entailment rules for identifying pairs of entailing and entailed text segments in the document input query, respectively.

8. The method of claim 7, wherein entailing text segment in the query comprises the entire query.

9. The method of claim 7, wherein the applying of the set of textual entailment rules comprises applying rules selected from the group consisting of: lexical rules that identify one or more of synonymy, hypernymy, and meronymy between arguments of an entailing text segment and an entailed text segment, lexico-syntactic rules that capture relations between a pair of predicate-argument tuples of an entailing text segment and an entailed text segment, and combinations thereof.

10. The method of claim 1, wherein the set of translated queries comprises at least five translated queries.

11. The method of claim 1, wherein the set of translated queries comprises at most, a predetermined number of translated queries.

12. The method of claim 1, wherein the set of retrieved documents comprises at least five retrieved documents.

13. The method of claim 1, wherein the set of retrieved documents comprises at most, a predetermined number of retrieved documents.

14. A computer program product comprising a non-transitory recording medium storing instructions, which when executed on a computer, causes the computer to perform the method of claim 1.

15. A system for performing the method of claim 1 comprising memory which stores instructions for performing the method of claim 1 and a processor in communication with the memory for executing the instructions.

16. A system for cross language information retrieval comprising:
a first machine translation component for translating an input query from a source language to a target language to provide a set of translated queries;
a retrieval component for retrieving documents from an associated document collection based on the translated queries;
a second machine translation component for translating the retrieved documents into the source language to generate a set of translated documents;
an entailment component for assessing an entailment relationship between each of the translated documents and the input query;
a refinement component for refining the set of translated documents based on the assessment of the entailment relationship; and
a processor which implements the first and second machine translation components, retrieval component, entailment component, and refinement component.

17. The system of claim 16, wherein the first machine translation component comprises a first statistical machine translation component and the second machine translation component comprises a second statistical machine translation component.

18. The system of claim 16, wherein the retrieval component uses a service for retrieving the documents from an associated document collection to which the retrieval component does not have access;

19. A method for cross language information retrieval comprising:
receiving an input query which includes at least one word in a source language;
translating the input query from the source language to a target language to provide a set of translated queries;
retrieving documents from a document collection based on the translated queries;
optionally, translating the retrieved documents into the source language to generate a set of translated documents;
assessing an entailment relationship between each of the translated documents and the input query or between each of the untranslated retrieved documents and the input query;
refining the set of translated or untranslated documents based on the assessment of the entailment relationship, the refining comprising at least one of:
retaining only those documents for which an entailment relationship is found; and
ranking the documents based on an entailment score; and
providing for a user to review documents in the refined set of translated documents or corresponding untranslated documents,
wherein at least one of the translating the input query, retrieving documents, assessing the entailment relationship, and refining the set of translated documents is performed with a computer processor.

20. A computer program product comprising a non-transitory recording medium storing instructions, which when executed on a computer causes the computer to perform the method of claim 19.
